(19) United States
(12) Patent Application Publication
(10) Pub. No.: US 2007/0162506 A1
(43) Pub. Date: Jul. 12, 2007

(54) Method and system for performing a redistribute transparently in a multi-node system

(75) Inventors: Ronen Grosman, Thornhill (CA); Keriley Kay Romanufa, Scarborough (CA); Robin D. Van Boeschoten, Markham (CA)

Correspondence Address: Sawyer Law Group LLP, P.O. Box 51418, Palo Alto, CA, 94303, US

(73) Assignee: International Business Machines Corporation, Armonk, NY (US)

(21) Appl. No.: 11/330,554

(22) Filed: Jan. 12, 2006

(51) Int. Cl. G06F 17/00

(52) U.S. Cl. 707/104.1

(57) ABSTRACT

A method for performing a redistribute of data in a database system including a plurality of nodes is disclosed. The data includes a plurality of partitions distributed between the plurality of nodes. At least one new node is being added. The method and system include selecting at least one partition of the plurality of partitions to be moved from the plurality of nodes only to the at least one new node. The method and system also include moving the at least one partition only to the at least one new node. The method and system further include removing the at least one partition from the plurality of nodes.

### FIELD OF THE INVENTION

The present invention relates to database systems and more particularly to a method for redistributing data between nodes of the database system.

### BACKGROUND OF THE INVENTION

Database systems may use multiple nodes for storing data in one or more tables. In a multiple nodes system, portions of a particular table may be spread across the nodes in the database system. For example, data for a table may be divided into partitions, each of which has an associated index. There may be one partition per node or there may be more than one partition per node. For example in the case of multi-dimensional clustering (MDC) tables, the partitions are indexed based upon a key, such as a particular row or column. Thus, one or more partitions may be stored on each of the nodes. The nodes may thus be part of a shared disk and/or a shared file database system. In order to account for growth in conventional database systems, one of ordinary skill in the art will readily recognize that one or more nodes may be added. Once a node is added, the data stored in the nodes is redistributed between the nodes.

FIG. 1 depicts a conventional method 10 for redistributing data between nodes in a database system. The number of partitions is provided, via step 12. The index for each of the partitions may thus be provided in step 12. Consequently, step 12 may include hashing the records in tables to particular partitions. The hash, and thus the partitions, may set to be a number greater than or equal to the total number of nodes in step 12. For example, if an MDC is used, the number of partitions may be greater than the number of nodes. Once new node(s) are added, partitions are redistributed between all of the available nodes, via step 14. This redistribution is typically accomplished by placing all of the data for the table being redistributed into a single file, then loading the data onto the nodes or through moving rows one at a time between nodes. Thus, data from the partitions are provided to the new node(s) and the preexisting nodes in step 14. The indexes for the partitions are then accounted for, via step 16. Step 16 may thus include generating indexes for each partition on the node to which the partition is being moved as well as removing the index for each partition on the node at which the partition previously resided or when moving rows one at a time though deleting and inserting index entries corresponding to each individual row being moved.

Although the method 10 functions, one of ordinary skill in the art will readily recognize that there are significant drawbacks. If the number of partitions is set to the number of preexisting nodes in step 12, then the number of indexes is also equal to the number of preexisting nodes. When new nodes are added, it may be difficult to distribute the index across all of the nodes in step 16 because the number of nodes is greater than the number of indexes. Even if the number of partitions is greater than or equal to the total number of nodes, both preexisting and new nodes, the redistribution and accounting for indexes in steps 14 and 16 may consume a great deal of time. In particular, step 14 requires that the data for the table be brought together, then distributed. Thus, both preexisting and new nodes may receive new partitions. This operation may thus be time consuming. Moreover, the indexes need to be generated on and removed from the appropriate nodes. During these operations, the data may be inaccessible to a user. Consequently, the user of the data may be inconvenienced.

Accordingly, what is needed is a method and system for more efficiently redistributing data across multiple nodes. The present invention addresses such a need.

### BRIEF SUMMARY OF THE INVENTION

Embodiments of the present invention relate to a method, computer program product, and system for performing a redistribute of data in a database system including a plurality of nodes. The data includes a plurality of partitions distributed between the plurality of nodes. At least one new node is being added. The method, computer program product, and system provide for comprise selecting at least one partition of the plurality of partitions to be moved from the plurality of nodes only to the at least one new node; moving the at least one partition only to the at least one new node; and removing the at least one partition from the plurality of nodes.

The method, computer program product and system disclosed herein result in more efficient redistributing of data with new nodes and may perform the redistribution transparently.

### BRIEF DESCRIPTION OF SEVERAL VIEWS OF THE DRAWINGS

FIG. 1 is a flow chart depicting a conventional method for redistributing partitions between nodes.

FIG. 2 is a flow chart depicting one embodiment of a method in accordance with the present invention for redistributing data between nodes.

FIGS. 3A-3B depict one embodiment of a system in which data is redistributed in accordance with the present invention.

FIGS. 4A-4C depict one embodiment of a system in which data is redistributed and skew accounted for in accordance with the present invention.

FIGS. 5A-5B depict one embodiment of a system in which data is redistributed in accordance with the present invention using an MDC table with a shared file system or container.

FIGS. 6A-6B depict one embodiment of a system in which data is redistributed in accordance with the present invention using an MDC table without a shared file system or container.

FIGS. 7A-7B depict one embodiment of a system in which data is redistributed in accordance with the present invention using table partitioning and a shared file system.

FIGS. 8A-8B depict one embodiment of a system in which data is redistributed in accordance with the present invention using table partitioning without a shared file system.

FIG. 9 is a flow chart depicting one embodiment of a method in accordance with the present invention for transparently accounting for moving partitions and indexes when redistributing data between nodes.

FIG. 10 is a flow chart depicting another embodiment of a method in accordance with the present invention for transparently accounting for indexes when redistributing data between nodes.

FIG. 11 is a diagram depicting one embodiment of a data processing system used in conjunction with the method and system in accordance with the present invention.

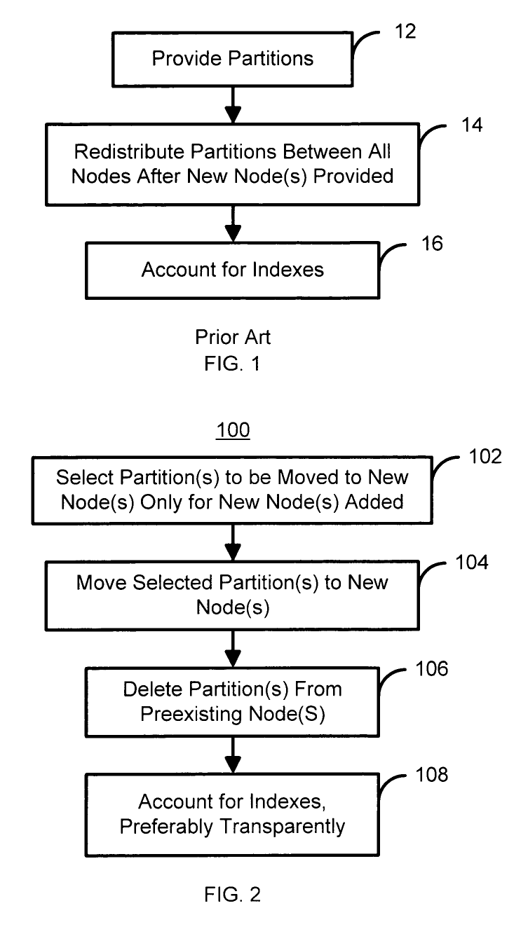

### DETAILED DESCRIPTION OF THE INVENTION

The present invention relates to systems, especially database systems. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention provides a method for performing a redistribute of data in a database system including a plurality of nodes. The data includes a plurality of partitions distributed between the plurality of nodes. At least one new node is being added. The method comprises selecting at least one partition of the plurality of partitions to be moved from the plurality of nodes only to the at least one new node. The method also comprise moving the at least one partition only to the at least one new node. The method also comprise removing the at least one partition from the plurality of nodes.

The present invention will be described in terms of particular database systems and particular numbers of partitions. However, one of ordinary skill in the art will readily recognize that the method is consistent with other systems, database systems and other numbers of partitions. Moreover, the present invention is described in the context of a database system. However, one of ordinary skill in the art will readily recognize that the system/database system may simply be a cluster, or part of, a larger database/computer system.

To more particularly describe the present invention, refer to FIG. 2, depicting a flow chart depicting one embodiment of a method 100 in accordance with the present invention for redistributing data between nodes. The method 100 is used in conjunction with a database system that already has at least one, and more preferably a plurality, of nodes (preexisting nodes). The method 100 is also preferably used when one or more nodes (new node(s)) are added to the database system, necessitating a redistribution of the data. The database system already includes data, preferably in the form of tables. The data are distributed in partitions. In one embodiment, the number of partitions is greater than the number of preexisting nodes. In a preferred embodiment, the number of partitions is at least equal to the maximum number of nodes expected to be allowed in the database system. The method 100, therefore, preferably commences after the data on the database system have been divided into partitions. Also in a preferred embodiment, this is accomplished by hashing each record in a table to a number, where the number corresponds to a partition.

At least one partition of the partitions to be moved from one or more of the preexisting nodes only to the new node(s) is selected for new node(s) added, via step 102. Step 102 thus selects one or more partitions to be moved from the preexisting nodes only to the new nodes. The redistribution, therefore, preferably does not move partitions from one preexisting node to another preexisting node. In a preferred embodiment, this selection is accomplished using a global ownership table (not shown in FIG. 2). The global ownership table indicates the preexisting nodes′ ownership and, in response to the redistribution, the new nodes′ ownership of partitions. The global ownership table may thus be used to distinguish between preexisting and new nodes and to select partitions to be moved in the redistribution based on the ownership. Thus, using the information in the global ownership table, it may be ensured that partitions are moved only to new nodes and that preexisting nodes may, at most, only have partitions deleted.

In addition to only being moved to new nodes, the partition(s) may be selected in step 102 based on other and/or additional criteria. For example, in one embodiment, the selection in step 102 is performed in order to reduce or minimize a difference between the data stored in each of the nodes, preferably including both the preexisting and new nodes. In one embodiment, this is accomplished by weighting each partition based on the amount of data stored therein. The partitions are then selected such that the weight difference for each node in the database system is minimized. Consequently, the skew (difference in the amount of data stored on each node) may be reduced or minimized.

The partition(s) selected in step 102 are moved only to the new node(s), via step 104. Thus, in step 104 partitions are moved only to new nodes. Partitions are not moved to preexisting nodes. The partition(s) that have been moved are deleted from the preexisting node(s), via step 106. Thus, as stated above, steps 102-104 only remove partition(s) from preexisting node(s) and add partition(s) to the new node(s).

Steps 102 and 104 are preferably accomplished using a two-step hash function for each row. Thus, rows may not be hashed directly to a node. Instead, rows are hashed to partitions. The partitions may be considered substructures for nodes. The partitions are selected for movement in step 102. For example, steps 102 and 104 are preferably performed by hashing a row to a number between 1 and N, where N is small but greater than the maximum final number of nodes expected in the database system. The N substructures to which the rows are hashed are the partitions. Partitions, and thus rows, are selected for movement in step 102. As a result, the two-step hash function for row partitioning may provide in order to obtain substantially instantaneous re-partitioning when nodes are either added or removed.

In addition to actually moving the data, the indexes corresponding to the partitions may be transparently accounting for, via step 108. The indexes are transparently accounted for if the redistribution of data and index generation and removal (if any) occur with little or no effect on a user of the data. In one embodiment, step 108 is accomplished by providing a new index for each partition moved on the new node and by marking the index entries for each partition moved as deleted on the corresponding preexisting node. Marking the index entries for an entire partition as deleted by marking the partition is deleted on the preexisting allows the preexisting node to skip data and operations associated with the index entries associated with the moved partition , and thus the partition, without actually deleting the partition or index entries immediately.

Steps 104, 106, and 108 may also include creating an MDC table (not shown in FIG. 2) with a key corresponding to the partitions (which are preferably extents for the MDC table). When an MDC table is used in a shared disk subsystem, the redistribution in steps 104 (move partition), 106 (remove partition), and 108 (account for indexes) may simply include a remapping of ownership of each extent in the table. Thus, for a database system having M preexisting nodes, N partitions with N>M, and I new nodes, each partition selected in step 102 would be moved from an index having a value≦M to one having an index of greater than M. With this scheme all records in the data which map to a particular index would exist on a set of easily identifiable extents. In addition, if separate disks are used, instead of having to do a full rehash of each row and potentially move every row, only be full extents are moved at time to significantly reduce the cost of redistribute.

In order to account for the indexes in step 108, several mechanisms might be used in conjunction with an MDC table. In one embodiment, all indexes may be invalidated and then rebuilt after the re-partition operation in steps 104 and 106. For indexes containing the partitioning key from the MDC table, a set number of levels for the partitioning key may be predetermined at the top of the index. For each partitioning key value, therefore, the subtree associated with it could be moved to the new node. In addition, the new node may rebuild the index using index merge operations. For indexes containing or not containing the partitioning key an index scan could be performed. As discussed above, the keys for partitions/extents moved to new nodes may be marked as pseudo deleted on the preexisting node(s). On the new node to which the extent is move, insert may be performed for all keys corresponding to extents mapped to this new node.

If a range partitioned table is used, the indexes may be mapped to an individual range partitioned table. For SMS tablespaces each partition may be mapped to an individual container. For DMS, each partition may be mapped to an individual object within the tablespace. If the database system is a shared disk system, for SMS tablespaces, the individual files of the range partitioned tables may be reassigned based on the scheme that with M node, node M owns files X if (X mod M=m), and with M+1 nodes node m owns file X if (X mod (M+1)=m). This assignment may also be based on an ownership lookup table with entries 1 . . . N. On a non shared disk system a redistribute would be a whole object movement operation. In order to account for the indexes, step 108 may use current roll in/roll out partition operations with partition removal being instantaneous when it occurs, and an attachment may utilize a background rebuild.

Using the method 100, redistribution may be improved. Because partitions are only moved to a new node and removed from preexisting nodes, movement of data is more efficient. In addition, index updates may be made simpler. Furthermore, the granularity of movement of the partitions may be larger than that in conventional methods. Consequently, efficiency of the redistribution is further improved. Furthermore, the redistribution may be made transparent to the user. Stated differently, the user may be able to substantially instantaneously access data in partitions being redistributed to a new node. In a shared disk system, the redistribution may be considered to be substantially instantaneous. Moreover, when range partitions roll in/roll out operations are used, index maintenance may be more efficient because as roll out may be a substantially instantaneous operation and may not require any online index maintenance.

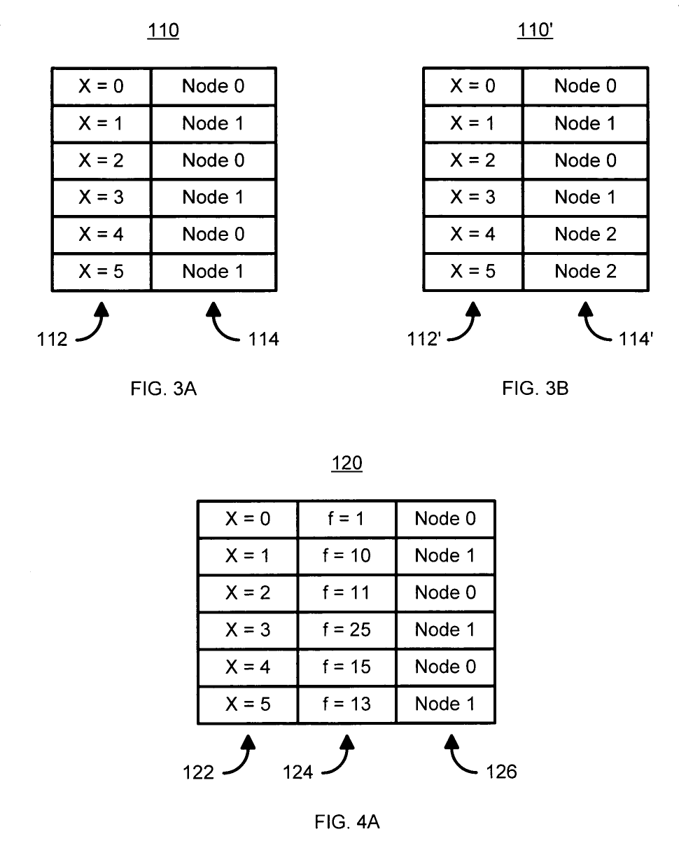

FIGS. 3A-3B depict one embodiment of a system 110/110′ in which data is redistributed in accordance with the present invention. FIG. 3A depicts the system 110 prior to the redistribution operation. FIG. 3A may thus be considered to depict a global ownership table for the system 110 prior to any redistribution. The system 110 includes two nodes, Node 0 and Node 1 shown in column 114 and six partitions, X=0, X=1, X=2, X=3, X=4, and X=5 shown in column 112. As can be seen by comparing columns 112 and 114, even numbered partitions X=0, X=2, and X=4 reside on Node 0 while odd numbered partitions X=1, X=3, and X=5 reside on Node 1. FIG. 3B depicts the system 110′ after the addition of a new node and redistribution using the method 100. Thus, a new node, Node 2, has been added to preexisting nodes Node 0 and Node 1. Using steps 102 and 104, the partitions X=4 and X=5 have been selected and moved to the new Node 2. Thus, no partitions are transferred between preexisting Nodes 0 and 1. Instead, partitions X=4 and 5 are provided on the new Node 2 and removed from preexisting Nodes 0 and 1. Consequently, each preexisting Node 0 and 1 has one less partition. In the embodiment shown, the partitions are equally distributed between the three Nodes 0, 1, and 2. Although this may be preferred, in an alternate embodiment, the Nodes 0, 1, and 2 may have a different number of partitions. Partitions X=0-5, and thus the rows corresponding to each partition X=0-5 are redistributed. Using step 108, the indexes for the partitions X=0-5 may be transparently accounted for by, for example, marking corresponding index entries for 4 and 5 as being pseudo deleted.

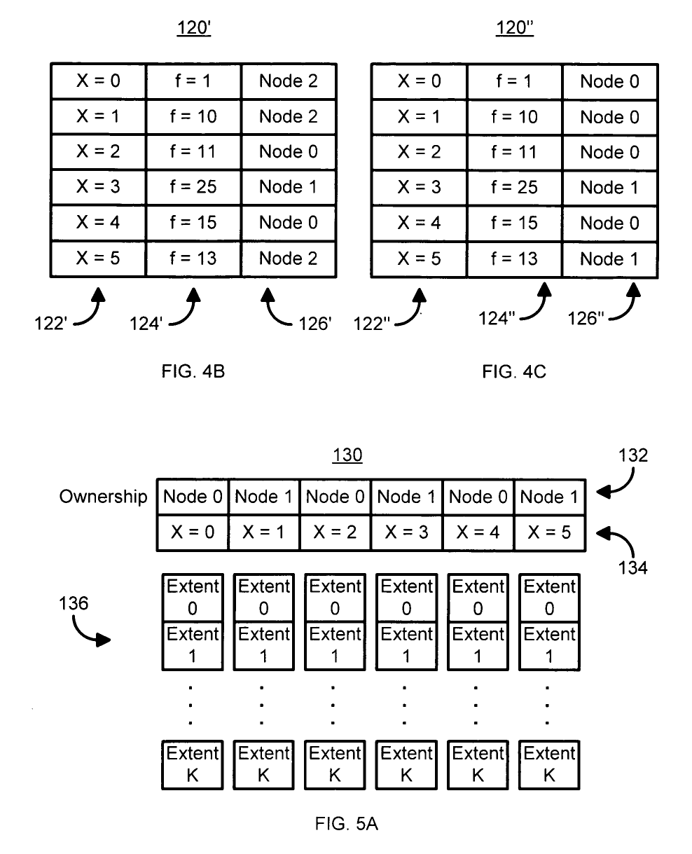

FIGS. 4A-4C depict one embodiment of a system 120/120′/120″ in which data is redistributed and skew accounted for in accordance with the present invention. FIG. 4A depicts the system 120 prior to the redistribution operation. FIG. 4A may thus be considered to depict a global ownership table for the system 120 prior to any redistribution. The system 120 includes two nodes, Node 0 and Node 1 in column 122, and six partitions, X=0, X=1, X=2, X=3, X=4, and X=5 in column 126. The amount of data stored in each partition is depicted in column 124 and corresponds to the factor f shown in column 124. Thus, the partition X=0 stores the least amount of data, while the partition X=3 stores the most. As can be seen by comparing columns 122 and 126, even numbered partitions X=0, X=2, and X=4 reside on Node 0 while odd numbered partitions X=1, X=3, and X=5 reside on Node 1.

FIG. 4B depicts the system 120′ after the addition of a new node and redistribution using the method 100 in which partitions are selected for removal also based on reducing the skew between nodes. Consequently, in addition to ensuring that partitions are moved only to a new node, the difference in the amount of data stored in each node is desired to be reduced. A new node, Node 2, has been added to preexisting nodes Node 0 and Node 1. Using steps 102 and 104, the partitions X=0, 1, and 5 have been selected and moved to the new Node 2. Thus, no partitions are transferred between preexisting Nodes 0 and 1. Instead, partitions X=0, 1, and 5 are provided on the new Node 2 and removed from preexisting Nodes 0 and 1. Consequently, preexisting Node 0 has one less partition and preexisting Node 1 has one less partition. Further, the difference in the amount of data stored in each node is reduced. For example, viewing column 124′, it can be seen that the total weight for Node 0 is twenty-five (for partitions X=2 and 4), the total weight for Node 1 is twenty-five (for partition X=3), and the total weight for Node 2 is twenty-four (for partitions X=0, X=1, and X=5). Using step 108, the indexes for the partitions X=0-5 may be transparently accounted for by, for example, marking index entries for partitions 0, 1 and 5 as being pseudo deleted by marking the partitions as detached.

Similarly, FIG. 4C depicts the system 120″ if the method 100 is used to redistribute partitions between preexisting Nodes 0 and 1 only to reduce skew. Because the method 100 is not being used to account for additional nodes, partitions are transferred between nodes. In particular, partition X=1 is transferred to Node 0. As can be seen in column 124″, Node 0 has a total weight of thirty-seven and Node 1 has a total weight of thirty-eight. Consequently, the skew between the Nodes 0, 1, and 2 may be relieved.

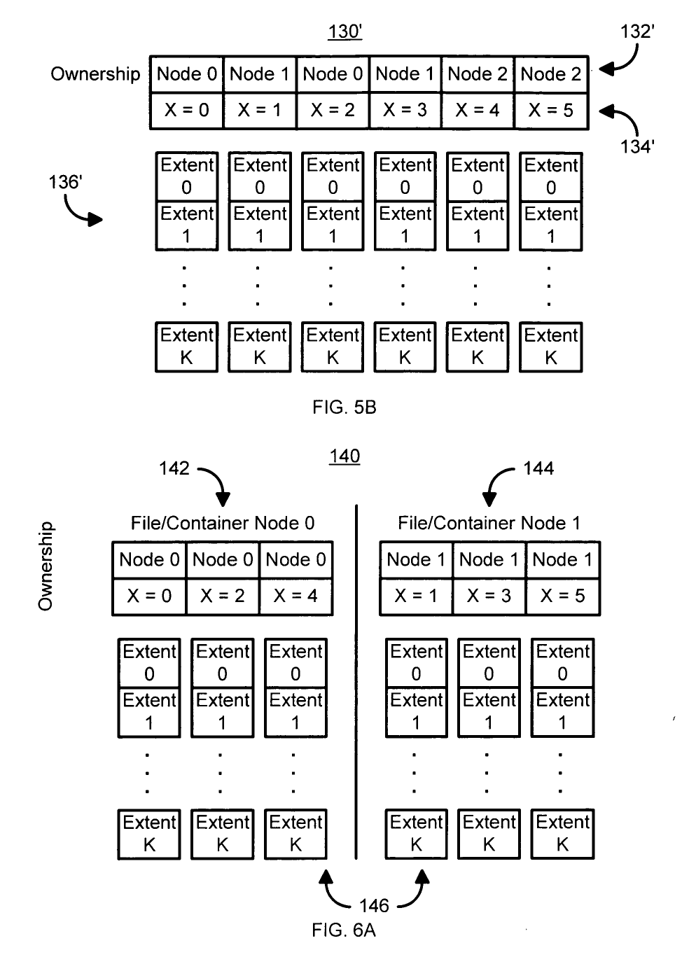

FIGS. 5A-5B depict one embodiment of a system 130/130′ in which data is redistributed in accordance with the present invention using an MDC table with a shared file system or container. FIG. 5A depicts the system 130 prior to the redistribution operation. FIG. 5A may thus be considered to depict the MDC table for the system 130 prior to any redistribution. The system 130 includes two nodes, Node 0 and Node 1 in ownership row 132, and six partitions, X=0, X=1, X=2, X=3, X=4, and X=5 in row 134. The extents 136 are for each of the partitions. Each extent preferably has a size of thirty-two or fifty-four megabytes. The MDC table is preferably indexed based upon the partitions, X=0-5. In the embodiment shown, each of the partitions shown in row 134 includes the same number of extents. However, in another embodiment, the partitions may have a different number of extents. As can be seen in rows 132 and 134, even numbered partitions X=0, X=2, and X=4 reside on Node 0 while odd numbered partitions X=1, X=3, and X=5 reside on Node 1.

FIG. 5B depicts the system 130′ after the addition of a new node and redistribution using the method 100 in accordance with the present invention. Thus, a new node, Node 2, has been added to preexisting nodes Node 0 and Node 1. Using steps 102 and 104, the partitions X=4 and X=5 have been selected and moved to the new Node 2. Thus, no partitions are transferred between preexisting Nodes 0 and 1. Instead, partitions X=4 and 5 are provided on the new Node 2 and removed from preexisting Nodes 0 and 1 by remapping the nodes and partitions in rows 132′ and 134′. Consequently, each preexisting Node 0 and 1 has one less partition. In the embodiment shown, the partitions are equally distributed between the three Nodes 0, 1, and 2. Although this may be preferred, in an alternate embodiment, the Nodes 0, 1, and 2 may have a different number of partitions. Partitions X=0-5, and thus the extents 136 corresponding to each partition X=0-5 are redistributed. Using step 108, the indexes for the partitions X=0-5 may be transparently accounted for by, for example, marking index entries for 4 and 5 as being pseudo deleted.

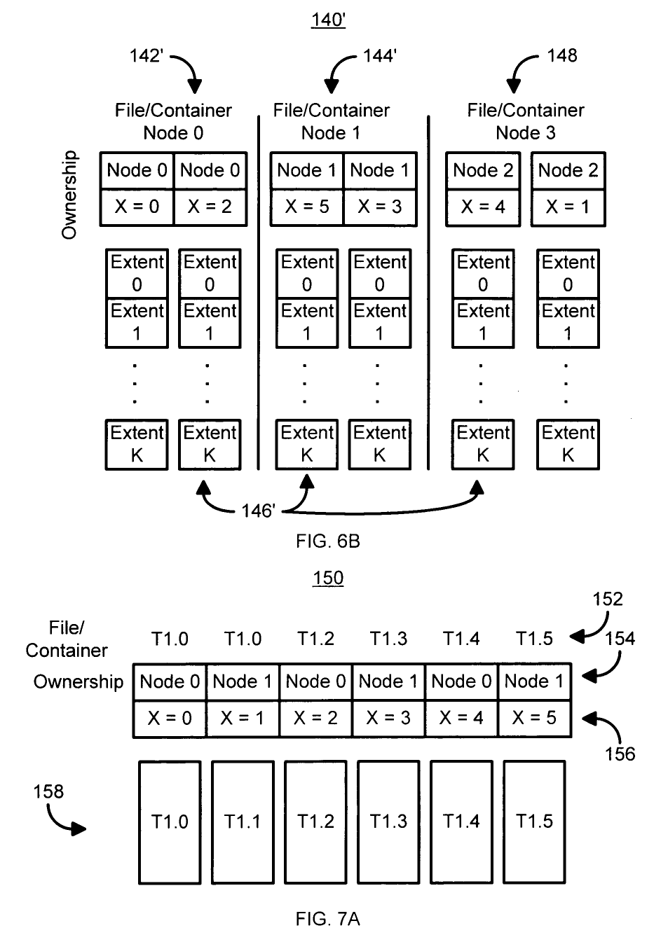

FIGS. 6A-6B depict one embodiment of a system 104/104′ in which data is redistributed in accordance with the present invention using an MDC table without a shared file system or container. FIG. 6A depicts the system 140 prior to the redistribution operation. The system 140 includes two nodes, Node 0 and Node 1 in containers 142 and 144, respectively. The six partitions, X=0, X=1, X=2, X=3, X=4, and X=5 of the database system 140 are thus distributed into the two containers 142 and 144. The extents 146 are for each of the partitions and are thus also distributed between the two containers 142 and 144. The MDC table is preferably indexed based upon the partitions, X=0-5. In the embodiment shown, each of the partitions X=0 through X=5 includes the same number of extents. However, in another embodiment, the partitions may have a different number of extents. As can be seen in containers 142 and 144, even numbered partitions X=0, X=2, and X=4 reside on Node 0 while odd numbered partitions X=1, X=3, and X=5 reside on Node 1.

FIG. 6B depicts the system 140′ after the addition of a new node and redistribution using the method 100 in accordance with the present invention. Thus, a new node, Node 2, has been added to preexisting nodes Node 0 and Node 1. Using steps 102 and 104, the partitions X=4 and X=5 have been selected and moved to the new Node 2 and thus to new container 148. Thus, no partitions are transferred between preexisting Nodes 0 and 1 (containers 142′ and 144′). Instead, partitions X=4 and 5 and thus their corresponding data are shipped to the new Node 2 (container 148) and removed from preexisting Nodes 0 and 1 (containers 142′ and 144′). Consequently, each preexisting Node 0 and 1 has one less partition. In the embodiment shown, the partitions are equally distributed between the three Nodes 0, 1, and 2. Although this may be preferred, in an alternate embodiment, the Nodes 0, 1, and 2 may have a different number of partitions. Partitions X=0-5, and thus the extents 136 corresponding to each partition X=0-5 are redistributed. Using step 108, the indexes for the partitions X=0-5 may be transparently accounted for by, for example, marking index entries for 4 and 5 as being pseudo deleted.

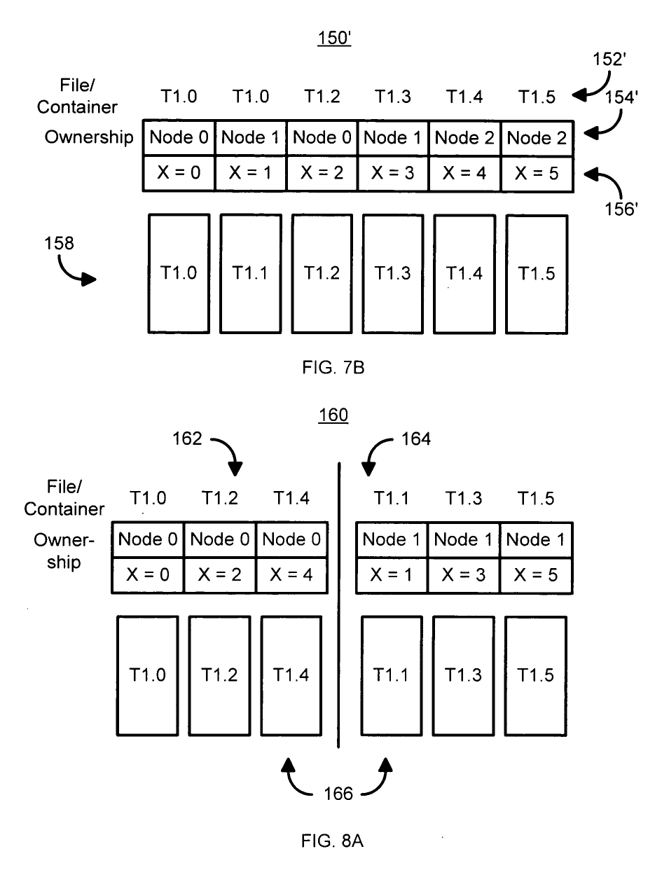

FIGS. 7A-7B depict one embodiment of a system 150 in which data is redistributed in accordance with the present invention using table partitioning and a shared file system. FIG. 7A depicts the system 150 prior to the redistribution operation. FIG. 7A may thus be considered to depict a range table for the system 150 prior to any redistribution. The system 150 includes file containers depicted in row 1 50, two nodes, Node 0 and Node 1 shown in ownership row 154, six partitions, X=0, X=1, X=2, X=3, X=4, and X=5 shown in row 156 and data in row 158. As can be seen by comparing rows 154 and 156, even numbered partitions X=0, X=2, and X=4 reside on Node 0 while odd numbered partitions X=1, X=3, and X=5 reside on Node 1.

FIG. 7B depicts the system 150′ after the addition of a new node and redistribution using the method 100. Thus, a new node, Node 2, has been added to preexisting nodes Node 0 and Node 1. Using steps 102 and 104, the partitions X=4 and X=5 have been selected and moved to the new Node 2. Thus, no partitions are transferred between preexisting Nodes 0 and 1. Instead, partitions X=4 and 5 are provided on the new Node 2 and removed from preexisting Nodes 0 and 1. Consequently, each preexisting Node 0 and 1 has one less partition. In addition, the partitions X=4 and 5 are provided on the new Node 2 and removed from preexisting Nodes 0 and 1 by remapping the nodes and partitions in rows 154′ and 156′. In the embodiment shown, the partitions are equally distributed between the three Nodes 0, 1, and 2. Although this may be preferred, in an alternate embodiment, the Nodes 0, 1, and 2 may have a different number of partitions. Partitions X=0-5, and thus the rows corresponding to each partition X=0-5 are redistributed. Using step 108, the indexes for the partitions X=0-5 may be transparently accounted for by, for example, marking index entries for 4 and 5 as being pseudo deleted.

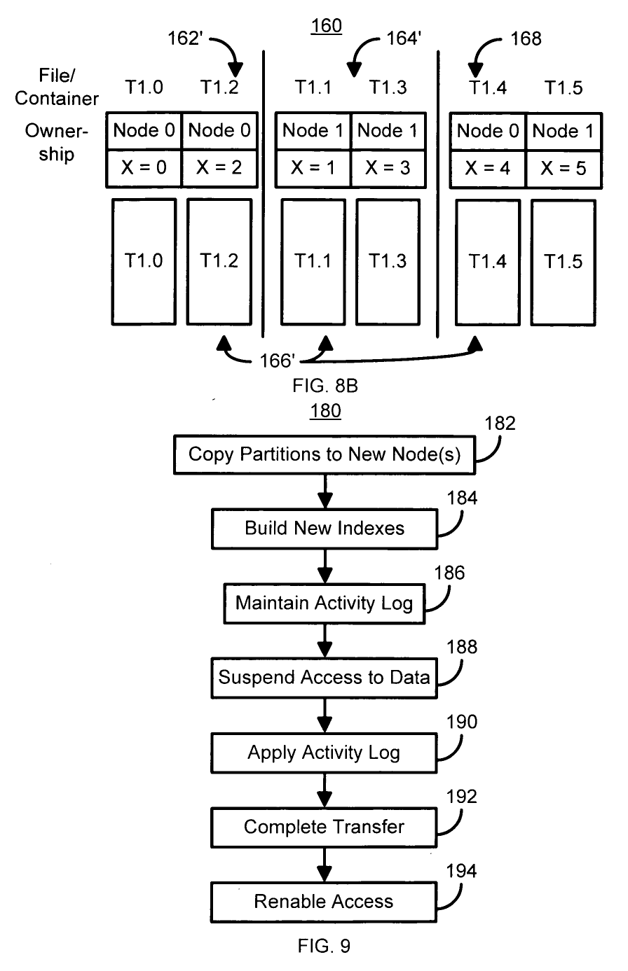

FIGS. 8A-8B depict one embodiment of a system 160/160′ in which data is redistributed in accordance with the present invention using table partitioning without a shared file system. FIG. 8A depicts the system 160 prior to the redistribution operation. The system 160 includes two nodes, Node 0 and Node 1 in containers 162 and 164, respectively. The six partitions, X=0, X=1, X=2, X=3, X=4, and X=5 of the database system 140 are thus distributed into the two containers 162 and 164. The data in region 166 for each of the partitions and are thus also distributed between the two containers 162 and 164 . In the embodiment shown, each of the partitions X=0 through X=5 includes the same number of extents. However, in another embodiment, the partitions may have a different number of extents. As can be seen in containers 162 and 164, even numbered partitions X=0, X=2, and X=4 reside on Node 0 while odd numbered partitions X=1, X=3, and X=5 reside on Node 1.

FIG. 8B depicts the system 16′ after the addition of a new node and redistribution using the method 100 in accordance with the present invention. Thus, a new node, Node 2, has been added to preexisting nodes Node 0 and Node 1. Using steps 102 and 104, the partitions X=4 and X=5 have been selected and moved to the new Node 2 and thus to new container 168. Thus, no partitions are transferred between preexisting Nodes 0 and 1 (containers 162′ and 164′). Instead, partitions X=4 and 5 and thus their corresponding data are shipped to the new Node 2 (container 168) and removed from preexisting Nodes 0 and 1 (containers 162′ and 164′). Consequently, each preexisting Node 0 and 1 has one less partition. In the embodiment shown, the partitions are equally distributed between the three Nodes 0, 1, and 2. Although this may be preferred, in an alternate embodiment, the Nodes 0, 1, and 2 may have a different number of partitions. Partitions X=0-5 are redistributed. Using step 108, the indexes for the partitions X=0-5 may be transparently accounted for by, for example, marking index entries for 4 and 5 as being pseudo deleted.

Thus, using the method 100, the systems 110, 120, 130, 140, 150, and 160 may undergo a redistribution. Moreover, the redistribution may be more efficient and may require less data movement. Furthermore, the indexes may be accounted for transparently. FIG. 9 is a flow chart depicting one embodiment of a method 180 in accordance with the present invention for moving partitions and transparently accounting for indexes when redistributing data between nodes. The method 180 may be used to perform steps 104, 106, and 108 of the method 100. In general, the method 180 allows the data for the partition being redistributed to remain available during the redistribution in the method 100. Thus, the partition(s) being moved are copied to the new node, via steps 182. Thus, a copy of the data in the partition(s) is available on the original, preexisting node(s) as well as on the new node(s). The new index is built on each the new node for each of the partition(s) that were copied, via step 184. The new indexes built in step 184 are provided based upon the data that has already been copied to the new node. An activity log is maintained for each of the partition(s) being moved, via step 186. Thus, any operations for the data in the partition(s) being moved are recorded in the activity log. Access to the data in the partition(s), generally a table, is suspended, via step 188. Thus, a user may be briefly prevented from accessing the data. However, in one embodiment, step 188 may be performed once user(s) have at least temporarily stopped accessing the table. The activity log corresponding to the partition(s) being moved are applied to the new node(s) corresponding to the partition(s) being moved, via step 190. Thus, using step 190, any changes occurring while the indexes are built may be accounted for. The transfer is then completed, via step 192. Step 192 may include deleting the data in the partition(s) being moved from the preexisting node(s) and marking the index entries for each of the at least one partition as deleted. Access to the data may then be re-enabled, via step 194. Thus, using the method 180, the partitions may be redistributed transparently and more efficiently.

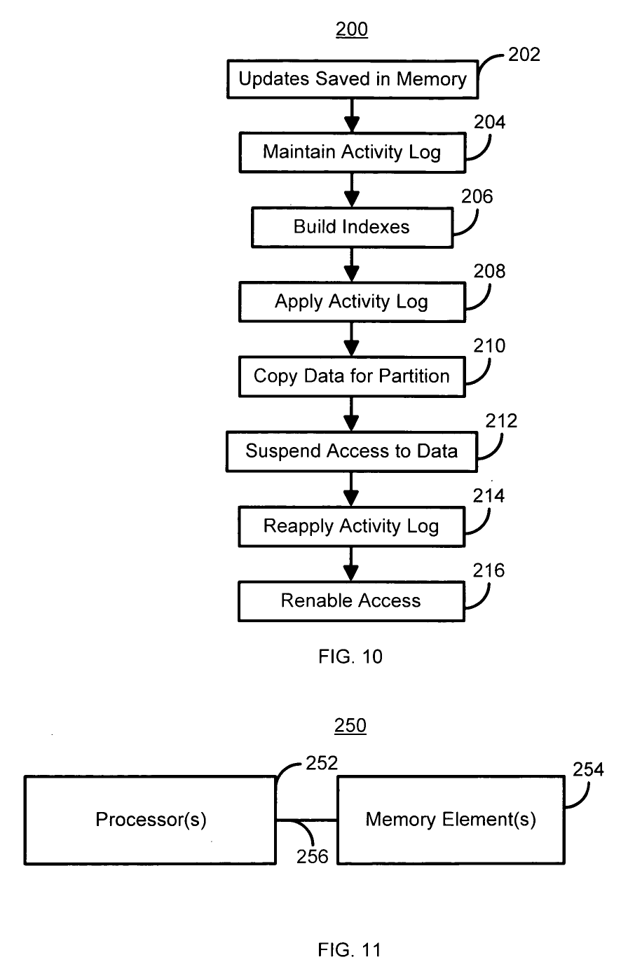

FIG. 10 is a flow chart depicting another embodiment of a method 200 in accordance with the present invention for transparently accounting for moving partitions and indexes when redistributing data between nodes. The method 200 may be used to perform steps 104, 106, and 108 of the method 100. In general, the method 200 allows the data for the partition being redistributed to remain available during the redistribution in the method 100. In addition, the method 200 may also avoid maintaining two copies of data during the redistribution.

Any updates to the partition(s) being moved are stored in memory, via step 202. Thus, actual access to the data stored on disk may be suspended in or prior to step 202. In addition, an activity log is maintained for each of the at least one partition on the plurality of nodes, via step 204. Note that steps 202 and 204 may be combined. The new index is built on the new node(s) to which the partition is to be moved, via step 206. cargo on each of the at least one node for each of the at least one partition. The activity log in memory is applied for each of the partition(s) moved to the new node, via step 208. The data for the partition is copied to the new node, via step 210. Access to data in the partition(s) being moved is suspended, via step 212. Also in step 208 ownership of the partition(s) may be transferred from the preexisting node(s) to new node(s). The activity log for each of the partition(s) is reapplied for each new node, via step 214. Thus, any changes to the data in the partition may be accounted for. The user may then be allowed to access the data in the partition(s) again, via step 216.

Thus, using the method 200, the systems 110, 120, 130, 140, 150, and 160 may undergo a redistribution. Moreover, the redistribution may be more efficient and may require less data movement. Furthermore, the indexes may be accounted for transparently.

FIG. 11 is a diagram depicting one embodiment of a data processing system 250 used in conjunction with the method and system in accordance with the present invention. The data processing system 250 includes at least data processor(s) 252 and memory element(s) 254. The data processing system 250 is, therefore, suitable for storing and/or executing program code. In the embodiment shown, the data processor(s) 252 access the memory element(s) 254 via a system bus 256. The data processing system 250 may also include input/output device(s) (not shown). The memory element(s) 254 may include local memory employed during actual execution of the program code, bulk storage, and cache memories which provide temporary storage of at least some program code in order to reduce the number of times code must be retrieved from bulk storage during execution. The memory element(s) 254 might also include other computer-readable media, such as a semiconductor or solid state memory, magnetic tape, a removable computer diskette, a random access memory (RAM), a read-only memory (ROM), a rigid magnetic disk, and an optical disk, such as a read-only memory (CD-ROM), and compact disk—read/write (CD-R/W). Thus, the data processing system 250 may be used in performing the methods 100, 180, and 200 to redistribute the partitions of the systems 110, 120, 130, 140, 150, and 160.

The present invention has been described in accordance with the embodiments shown, and one of ordinary skill in the art will readily recognize that there could be variations to the embodiments, and any variations would be within the spirit and scope of the present invention.

The invention can take the form of an entirely hardware embodiment, an entirely software embodiment, or an embodiment containing both hardware and software elements. In one aspect, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk—read-only memory (CD-ROM), and compact disk-read/write (CD-R/W). A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Accordingly, many modifications may be made by one of ordinary skill in the art without departing from the spirit and scope of the appended claims.

We claim:

1. A method for performing a redistribute of data in a database system including a plurality of nodes, the data including a plurality of partitions distributed between the plurality of nodes, at least one new node being added, the method comprising:
selecting at least one partition of the plurality of partitions to be moved from the plurality of nodes only to the at least one new node;
moving the at least one partition only to the at least one new node; and
removing the at least one partition from the plurality of nodes.

2. The method of claim 1 wherein each of the plurality of nodes and each of the at least one new node include a portion of the data, the selecting further including:
choosing the at least one partition to minimize a difference between the portion of the data in each of the plurality of nodes and each of the at least one new node.

3. The method of claim 2 wherein the portion of the data for each of the plurality of nodes and each of the at least one new node corresponds to a weight and wherein the choosing further includes:
selecting the at least one partition such a weight difference that the weight for each of the plurality of nodes and each of the at least new node is minimized.

4. The method of claim 1 wherein the database system includes at least one multidimensional clustering (MDC) table, the at least one MDC table determining the plurality of partitions.

5. The method of claim 1 wherein the database system is a shared disk environment.

6. The method of claim 1 wherein the database system is not a shared disk environment and wherein the moving further includes:
shipping at least one partition across at least one disk.

7. The method of claim 1 wherein the database system includes a shared file system.

8. The method of claim 1 wherein database system does not includes a shared file system and wherein the moving further includes:
shipping at least one file container for the at least one partition.

9. The method of claim 1 wherein each of the at least one partition corresponds to an index and wherein the moving further includes:
transparently accounting for the index.

10. The method of claim 9 wherein the transparently accounting further includes:
providing a new index for each of the at least one partition.

11. The method of claim 9 wherein the transparently accounting includes:
marking the index for each of the at least one partition as deleted.

12. The method of claim 1 wherein each of the at least one partition corresponds to an index and wherein the moving further includes:
copying the at least one partition to the at least one node;
building the new index on each of the at least one node for each of the at least one partition;
maintaining an activity log for each of the at least one partition on the plurality of nodes;
suspending access to the data;
applying the activity log for each of the at least one partition on each of the at least one node; and
marking the index for each of the at least one partition as deleted.

13. The method of claim 1 wherein each of the at least one partition corresponds to an index, wherein the database system includes a memory and at least one disk and wherein the moving further includes:
storing any update to the at least one partition in memory;
maintaining an activity log for each of the at least one partition on the plurality of nodes;
building the new index on each of the at least one node for each of the at least one partition;
applying the activity log for each of the at least one partition on each of the at least one node;
copying the at least one partition to the at least one new node;
suspending access to the at least one partition;
reapplying the activity log for each of the at least one partition on each of the at least one node.

14. A system for performing a redistribute of data in a database system including a plurality of nodes, the data including a plurality of partitions distributed between the plurality of nodes, at least one new node being added, the method comprising:
an element for selecting at least one partition of the plurality of partitions to be moved from the plurality of nodes only to the at least one new node;
an element for moving the at least one partition only to the at least one new node; and
an element for removing the at least one partition from the plurality of nodes.

15. A computer program product comprising a computer-readable medium including a program for performing a redistribute of data in a database system including a plurality of nodes, the data including a plurality of partitions distributed between the plurality of nodes, at least one new node being added, the program including instructions for:
selecting at least one partition of the plurality of partitions to be moved from the plurality of nodes only to the at least one new node;
moving the at least one partition only to the at least one new node; and
removing the at least one partition from the plurality of nodes.

16. The computer program product comprising a of claim 15 wherein each of the plurality of nodes and each of the at least one new node include a portion of the data, and wherein the selecting instructions further include instructions for:
choosing the at least one partition to minimize a difference between the portion of the data in each of the plurality of nodes and each of the at least one new node.

17. The computer program product comprising a of claim 16 wherein the portion of the data for each of the plurality of nodes and each of the at least one new node corresponds to a weight and wherein the choosing instructions further include instructions fir:
selecting the at least one partition such a weight difference that the weight for each of the plurality of nodes and each of the at least new node is minimized.

18. The computer program product comprising a of claim 15 wherein the database system includes at least one multidimensional clustering (MDC) table, the at least one MDC table determining the plurality of partitions.

19. The computer program product comprising a of claim 15 wherein each of the at least one partition corresponds to an index and wherein the moving further instructions includes instructions for:
transparently accounting for the index.

20. The computer program product comprising a of claim 15 wherein each of the at least one partition corresponds to an index and wherein the moving further instructions include instructions for:
copying the at least one partition to the at least one node;
building the new index on each of the at least one node for each of the at least one partition;
maintaining an activity log for each of the at least one partition on the plurality of nodes;
suspending access to the data;
applying the activity log for each of the at least one partition on each of the at least one node; and
marking the index for each of the at least one partition as deleted.

21. The computer program product comprising a of claim 15 wherein each of the at least one partition corresponds to an index, wherein the database system includes a memory and at least one disk and wherein the moving further includes:
storing any update to the at least one partition in memory;
maintaining an activity log for each of the at least one partition on the plurality of nodes;
building the new index on each of the at least one node for each of the at least one partition;
applying the activity log for each of the at least one partition on each of the at least one node;
copying the at least one partition to the at least one new node;
suspending access to the at least one partition;
reapplying the activity log for each of the at least one partition on each of the at least one node.
